(19) United States
(12) Patent Application Publication
(10) Pub. No.: US 2024/0290212 A1
(43) Pub. Date: Aug. 29, 2024

(54) Method and system for classification of student progress in solving a complex problem

(71) Applicant: SIT Programming School AG, Schaffhausen (CH)

(72) Inventors: Sergey Shedov, Madrid (ES); Ivan Dobrosovestnov, Belgrade (RS); Daniil Imani, Beglrade (RS); Semen Obukhov, Belgrade (RS); Serg Bell, Singapore (SG); Stanislav Protasov, Singapore (SG)

(21) Appl. No.: 18/175,551

(22) Filed: Feb. 28, 2023

(51) Int. Cl. G09B 7/02; G06N 5/022

(52) U.S. Cl. CPC G09B 7/02; G06N 5/022

(57) ABSTRACT

A method and a system for automatic classification of study progress for multiple subjects corresponding to a particular test with an option for a subject to submit multiple solutions to the test over a period of time based on two-level clustering of abstraction of subject's solutions and subject's paths across different clusters of solution abstractions. Similarity of paths of subjects through solution abstraction clusters reflect the similarity of subjects' progress in learning a subject; subjects with paths grouped in the same cluster are considered to have a similar progress in learning a subject that is assessed with the given test.

### FIELD OF THE INVENTION

The present disclosure generally relates to the field of computer-assisted education. In particular, method and system for classification of subject's, for example, student's or job applicant's, progress in solving a complex problem through an extended period of time with a possibility to submit multiple versions of the solution to a given problem.

### BACKGROUND OF THE INVENTION

In recent years, a large portion of the educational process moved from physical brick and mortar classrooms to online resources like virtual classrooms. With such an advancement in the field of education, an important requirement that has consequently developed is that of testing the participant subjects. As a result, testing of subjects has been automated in different areas of education. There are different kinds of tests that are used nowadays. Some are short quizzes that the teachers resort to for checking subject understanding of the subjects during live lectures. The simplest form of automated testing is multiple-choice tests. Some other tests are designed to be more comprehensive and may require for the subject to provide more than a simple answer, for example, input each step of solving a mathematical, chemical, physical problem, or to write computer source code. In some tests, it is expected that subjects submit multiple versions of their solutions overtime before solving the problem.

Conventional testing systems collect and display results of all subjects who took a particular test. However, these conventional systems fail to provide the analysis of the solutions provided by each subject. More specifically, the fact that a subject ultimately solved a problem with a 100% score does not necessarily mean that the subject understands the subject. There are numerous scenarios in which a subject can provide a complete solution for a problem without understanding the subject of the problem, for example, by copying from other subjects, receiving assistance from instructors, or using other resources on the Internet.

Currently, only an instructor in personal communication with the subject can provide a true assessment of the subject's knowledge of a subject by reviewing the subject's notes and all the steps the subject took while solving a complex problem. This manual approach may be subjective and requires a significant amount of time making it in many cases prohibitively expensive.

A system and method are needed to allow for automated evaluation of a subject's progress in understanding a complex topic through the analysis of the evolution of the subject's solutions to a given problem submitted over time.

### SUMMARY OF THE INVENTION

The present invention discloses a method for automatic classification of study progress for multiple subjects corresponding to a particular test with an option for a subject to submit multiple solutions to the test. Although a student is the typical subject of the method, the method may also be used for other subjects who are not students.

The present invention relies on the method of two-level clustering of digital representations of subject solutions to a given problem.

First level is clustering of actual abstractions, for example, into a graph, of subject solutions into solution clusters.

An example of an abstraction of a solution that is a software program is a control flow graph (CFG) which is the graphical representation of control flow or computation during the execution of programs or applications. Control flow graphs represent the flow inside of a program unit.

The second level is clustering of paths of subjects through solutions clusters into behavioral clusters.

In an embodiment, such behavioral clusters are assigned labels reflecting certain behavior types indicating, for example, that subjects whose path through solution clusters fell into a given behavioral cluster successfully understood the subject, or obtained an external help in developing a solution, or lack understanding of the subject or at least one of its components.

### DESCRIPTION OF THE DRAWINGS

FIG. 1 illustrates a system for classification of study progress of multiple subjects in solving a complex problem, in accordance with an embodiment of the present disclosure.

FIG. 2A illustrates a step of solution cluster identification in a method for classification of study progress of multiple subjects in solving a complex problem, in accordance with an embodiment of the present disclosure.

FIG. 2B illustrates a step of solution cluster identification for multiple solution versions in a method for classification of study progress of multiple subjects in solving a complex problem, in accordance with an embodiment of the present disclosure.

FIG. 3 illustrates a step of behavioral cluster identification in a method for classification of study progress of multiple subjects in solving a complex problem, in accordance with an embodiment of the present disclosure.

FIG. 4 illustrates a step of path generation for each subject in a method for classification of study progress of multiple subjects in solving a complex problem, in accordance with an embodiment of the present disclosure.

### DETAILED DESCRIPTION

The method steps include collecting at least one solution version developed by at least one subject in response to the test; automatically abstracting each collected solution into a solution abstraction, for example, into a graph; grouping at least one solution abstraction, for example, a graph, into at least one solution cluster based on similarity of solution abstractions, for example, graphs, using a at least one solution clustering criteria; building a path for each individual subject, wherein each of the subject's path is an ordered sequence of at least one solution cluster to which at least of the subject's solutions belong; and grouping at least one path of at least one subject into at least one behavioral cluster based on at least one metric and at least one path clustering criteria.

In an alternative embodiment, the solution clustering criteria is based on at least one metric defined on the space of solution abstractions, for example, graphs.

In an alternative embodiment, the path clustering criteria is based on at least one metric defined on the space of paths through solution abstraction clusters.

In an embodiment, at least one behavioral cluster is assigned at least one textual, color-coded, shape-coded or otherwise descriptive label, for example, ‘a subject copied the solutions and does not understand the subject’, ‘a subject does not understand the subject and writes wrong code’, ‘a subject applied a different approach or approaches to solve the problem’, ‘a subject used one approach to solve the problem’, ‘a subject stayed in cluster for too long’, ‘a subject moves from one cluster to another often’, or ‘most solutions of the subject lay in an incorrect cluster, but the correct solution is another less numerous cluster’.

In an embodiment, clustering of solution abstractions, for example, graphs, into solution clusters is performed using a machine learning artificial intelligence system trained on previously analyzed solution abstractions, for example, graphs.

In an embodiment, clustering of paths into behavioral clusters is performed using a machine learning artificial intelligence system trained on previously analyzed paths.

In an embodiment, clustering of solution abstractions into solution clusters is performed using an expert artificial intelligence system.

In an embodiment, clustering of paths into behavioral clusters is performed using an expert artificial intelligence system.

In an embodiment, the step of identification of the clusters includes at least one of a Density-Based Spatial Clustering of Applications with Noise (DBSCAN) algorithm or a k-nearest neighbors (KNN) algorithm.

In an embodiment, the method further comprises determining outliers not belonging to other clusters and classifying the outliers as individual clusters.

The present invention discloses a method and system for classification of study progress of multiple subjects in solving a complex problem with an option for each subject to submit multiple versions of the solution to a given problem. In accordance with the present disclosure, the method includes collection of multiple solution versions from a plurality of subjects throughout a predetermined period of time.

In an embodiment, the predetermined period of time is determined by the designers of the course, the educational institution, the teacher, or the subject.

For example, the predetermined course of time can be several minutes or an entire semester. The purpose of the test is to provide a comprehensive understanding of a subject's progress in a given subject through allowing the subject to submit multiple versions of the solution over a predetermined period of time.

Each solution version that is collected is then abstracted to generate a solution abstraction, for example, a graph,. Solution abstractions, for example, graphs, are grouped together in different solution clusters based on similarity of solution abstractions to pre-existing solution clusters.

In an embodiment, if a solution abstraction, for example, a graph, of a particular solution version is not similar to any of the pre-existing solution clusters, a new solution cluster is formed that includes the specific solution abstraction, for example, a graph, wherein the newly formed solution cluster can be used in the future for solution clustering of the solution abstractions, for example, graphs.

Since multiple solution versions are created and submitted by the subject, it is possible to track the progress of the subject over a period of time. More specifically, the test question can be complex and may be designed in a manner that as a new lesson is taught to the subjects, the solutions submitted by the subject may also require an update in accordance with the latest lessons. As a result, the analysis of all of the solution versions submitted by one or more subjects can be used to build a path for each individual subject, wherein each of the subject's path is an ordered sequence of at least one solution cluster to which at least of the subject's solutions belong. Such a path of the subject's progress through solution clusters provides a systematic outlook of the subject's progress during the predetermined course of time. As a result, each subject is assigned a track.

In accordance with the present disclosure, after the paths for individual subjects have been built, the at least one path of at least one subject is grouped into at least one behavioral cluster based on at least one path clustering criteria.

In an embodiment, at least one of such behavioral clusters is assigned a label indicating the subject's progress in understanding the given subject.

Thus, the system and method, as disclosed in the present disclosure, facilitate obtaining a comprehensive understanding of the progress of multiple subjects for a given subject throughout a predetermined period of time by applying a two-level clustering process to abstractions, for example, graphs, of subjects' solutions.

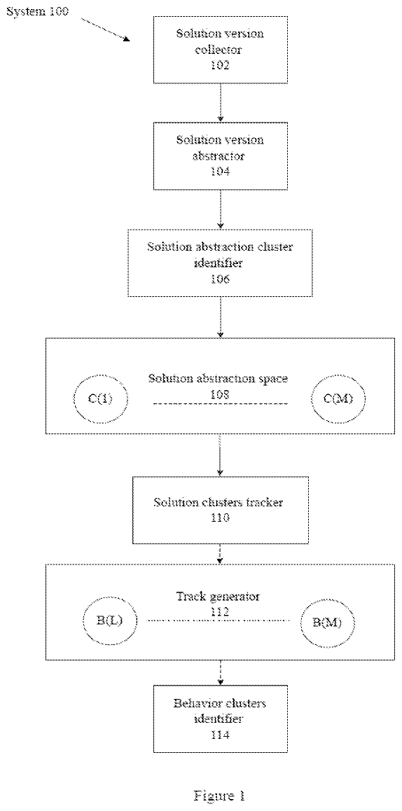

FIG. 1 illustrates a system for classification of study progress of multiple subjects in solving a complex problem 100, in accordance with an embodiment of the present disclosure. In accordance with an embodiment of the present disclosure, the system 100 comprises a solution version collector 102. The solution version collector 102 is configured to collect solution versions from the multiple subjects. Each solution version is assigned an identifier associated with the versions of the subject who submitted that version.

The system 100 further comprises a solution version abstractor 104. The solution version abstractor 104 is configured for automatically abstracting each collected solution version into a solution abstraction, for example, a graph.

The system 100 further comprises a solution cluster identifier 106. The solution clusters identifier 106 is configured to identify a solution cluster that is similar to at least one solution abstraction, for example, a graph, over the Solution Abstraction Space 108. The solution abstraction space 108 contains solution abstractions, for example, graphs, that are grouped into solution clusters based on a solution abstraction clustering criteria, for example, graph clustering criteria. In an embodiment, the system 100 is configured to maintain the list of solution clusters, wherein each solution abstraction cluster includes solution abstractions, for example, graphs, that are similar according to certain solution clustering criteria.

The system 100 further comprises a solution cluster tracker 110. The solution clusters tracker 110 is configured for identifying paths of individual subjects through solution clusters to which abstractions, for example, graphs, of the solution versions from one subject belong. Such identification is required to build a path for each individual subject, wherein each of the subject's path is an ordered sequence of at least one solution cluster to which at least of the subject's solution abstractions, for example, graphs, belong.

The system 100 further includes a path generator 112 for building the paths for individual subjects of abstractions, for example, graphs, of their solution versions across solution abstraction clusters.

The path of each subject generated by the path generator 112 reflects the subject's progress of understanding of the subject through the subject's progress in development of solution versions throughout the predetermined period of time. Subjects with similar paths have similar progress through understanding of the subject through the subject's progress in development of solution versions throughout the predetermined period of time. Thus, the present disclosure also includes a behavior clusters identifier 114.

In an embodiment, the system 100 is configured to maintain the list of behavior clusters that are generated based on at least one path clustering criteria. The behavior clusters identifier 114 is configured to group at least one path of at least one subject into at least one behavioral cluster based on at least one path clustering criteria.

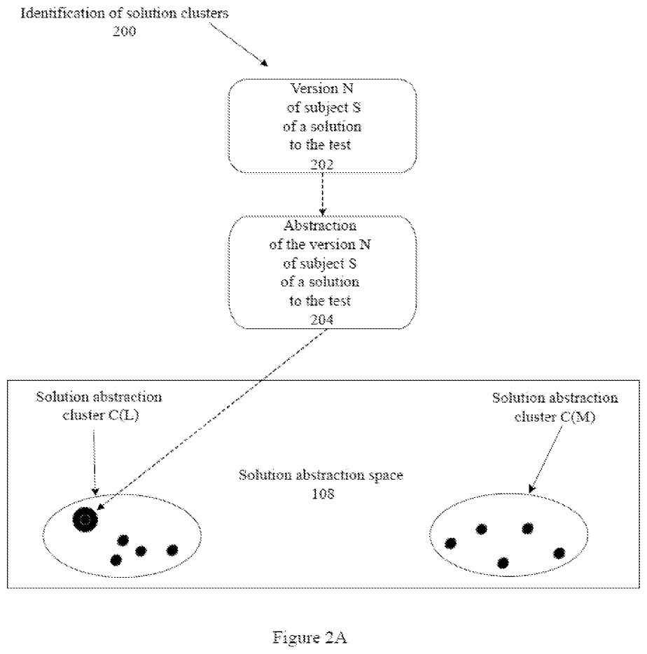

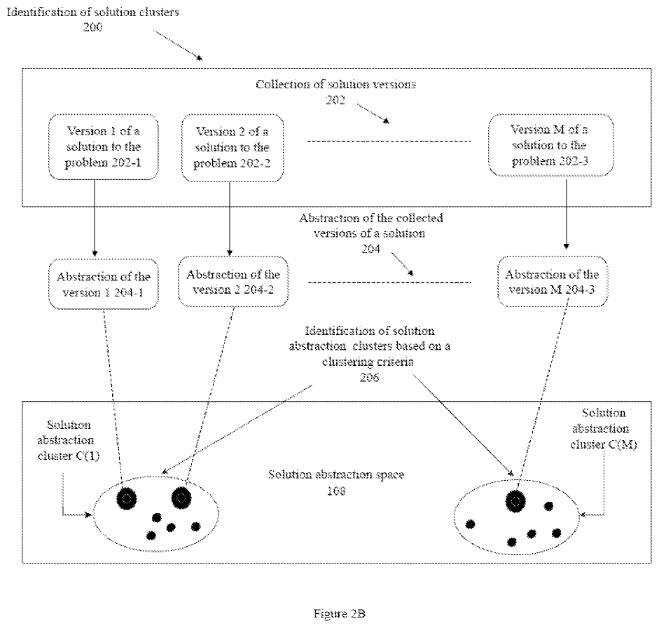

FIG. 2A provides an exemplary illustration on how the method includes collecting one solution version from one subject. FIG. 2A illustrates step 200 of solution cluster identification in a method for classification of study progress of multiple subjects in solving a complex problem. The method for classification of study progress for multiple subjects includes collection of solution versions from one or more subjects. The block diagram illustrated in FIG. 2A depicts the collection of one solution version from one subject.

At block 202, the step 200 for identification of solution clusters includes receiving a solution version N for a subject S as a solution to the test by the solution version collector 102. In an embodiment, each solution version is assigned an identifier associated with the version and the subject who submitted it.

At block 204, the step 200 for identification of solution clusters includes generating an abstraction, for example, a graph, of the solution version N of the subject S by the solution version abstractor 104.

The solution abstraction, for example, a graph, is then analyzed for being grouped into a relevant solution cluster within the space of all solution abstractions, for example, graphs, of the test 108 by the Solutions Clusters Tracker 110 based on similarity of solution abstractions, for example, graphs, using at least one solution clustering criteria. In an embodiment, the solution clustering criteria is based on at least one solution abstraction metric, for example, a graph metric.

FIG. 2B illustrates a step of solution cluster identification 200 for multiple solution versions in a method for classification of study progress of multiple subjects in solving a complex problem. The block diagram illustrated in FIG. 2B depicts the collection of multiple solution versions from one subject. The system and the method of the present disclosure are designed to collect multiple solution versions from multiple subjects, and FIG. 2B provides an exemplary illustration on how the method collects multiple solution versions from one subject.

At block 202, the exemplary method 200 for identification of solution clusters includes receiving multiple solution versions 202-1, 202-2, . . . , 202-3 from a subject as multiple solutions to the test over a predefined period of time. The multiple solution versions 202-1, 202-2, . . . , 202-3 together from a collection of solution versions 202 created by the solution version collector 102. In an embodiment, each solution version is assigned an identifier associated with the version and the subject who submitted that version.

At blocks 204-1, 204-2, . . . , 204-3, the step 200 for identification of solution clusters includes performing an abstraction, for example, generating a graph, of the solution versions 1, 2, . . . , M of the subject by the solution version abstractor 104.

The solution abstractions, for example, graphs, are then analyzed for being grouped into a relevant solution cluster within abstraction space of the versions 1 to M 108 based on similarity of solution abstractions, for example, graphs, using at least one solution clustering criteria by the solution clusters identifier 106 and grouped into the solution abstraction clusters C(1), . . . , C(M) within the solution abstraction space 108. In an embodiment, the solution clustering criteria is based on at least one solution abstraction metric, for example, a graph metric. In an embodiment, if the solution clusters identifier 106 fails to identify an existing solution cluster within which a particular solution abstraction, for example, a graph, matching the clustering criteria, then that solution abstraction, for example, a graph, may be considered an outlier solution abstraction, for example, a graph, and is then used to form a new solution abstraction cluster.

In an embodiment, the clustering of solution abstractions, for example, graphs, into solution abstraction clusters is performed using either an expert artificial intelligence system or a machine learning artificial intelligence system trained on previously analyzed solution abstractions, for example, graphs,. More specifically, the solution clusters identifier 106 performs the operation of clustering of solution abstractions, for example, graphs, into solution clusters and can be either an expert artificial intelligence system or a machine learning artificial intelligence system trained on previously analyzed solution abstractions, for example, graphs.

In an embodiment, the step of identification of the clusters includes the usage of at least one of a Density-Based Spatial Clustering of Applications with Noise (DBSCAN) algorithm or a k-nearest neighbors (KNN) algorithm.

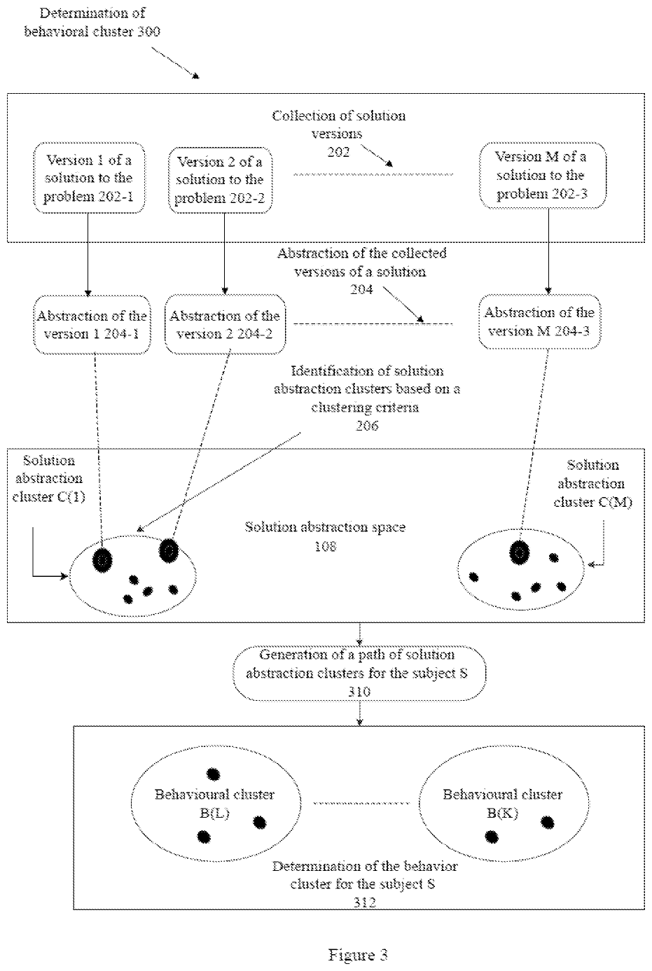

FIG. 3 illustrates step 300 of behavioral cluster identification in a method for classification of study progress of multiple subjects in solving a complex problem through clustering of paths of each subject through solution abstraction clusters over time. The step 300 for determination of a behavioral cluster includes the step 200 explained with reference to FIGS. 2A and 2B. FIG. 3 includes elements of FIG. 2B. Reference numerals are used to indicate the identical elements of FIG. 2B and FIG. 3

After the solution version abstractions, for example, graphs, are clustered into relevant solution clusters C(1), . . . , C(M) within the space 108, the step 300 includes, at block 310, building a path for the subject, wherein each of the subject's path is an ordered sequence of at least one solution abstraction cluster to which at least of the subject's solution abstractions, for example, graphs, belong. More specifically, the solution abstraction clusters tracker 108 is configured for identifying the solution abstraction clusters to which multiple abstractions, for example, graphs, of solution versions from one or more subjects belong. The system 100 includes a path generator 112 for building the paths for individual subjects.

The subject's progress through solution abstraction clusters reflects the subject's progress in understanding the subject through the analysis of the versions of different solutions submitted by the subject over time. In an embodiment, the method includes maintaining the list of behavior clusters that are generated based on at least one path clustering criteria. At block 312, the step 300 includes grouping at least one path of at least one subject into at least one behavioral cluster based on at least one path clustering criteria by the behavior clusters identifier 114.

In an embodiment, the behavior clusters are assigned at least one textual, color-coded, shape-coded or otherwise a descriptive label as identity markers. Some examples of descriptive labels include ‘a subject copied the solutions and does not understand the subject’, ‘a subject does not understand the subject and writes wrong code’, ‘a subject applied a different approach or approaches to solve the problem’, ‘a subject used one approach to solve the problem’, ‘a subject stayed in cluster for too long’, ‘a subject moves from one cluster to another often’, ‘most solutions of the subject lay in an incorrect cluster, but the correct solution is another less numerous cluster’, or ‘subject behavior is different from previously classified behavioral clusters’.

In an embodiment of the system 100, the clustering of paths into behavioral clusters is performed using either an expert artificial intelligence system or a machine learning artificial intelligence system trained on previously analyzed paths. More specifically, the behavior clusters identifier 114 performs the clustering of paths into behavioral clusters, and it can be either an expert artificial intelligence system or a machine learning artificial intelligence system trained on previously analyzed paths.

In an embodiment, the step of identification of the clusters includes the usage of at least one of a Density-Based Spatial Clustering of Applications with Noise (DBSCAN) algorithm or a k-nearest neighbors (KNN) algorithm.

In accordance with an embodiment, if the behavior clusters identifier 114 fails to identify an existing behavior cluster within which a particular path may be grouped, then that path may be considered an outlier path and is then used to form a new behavior cluster.

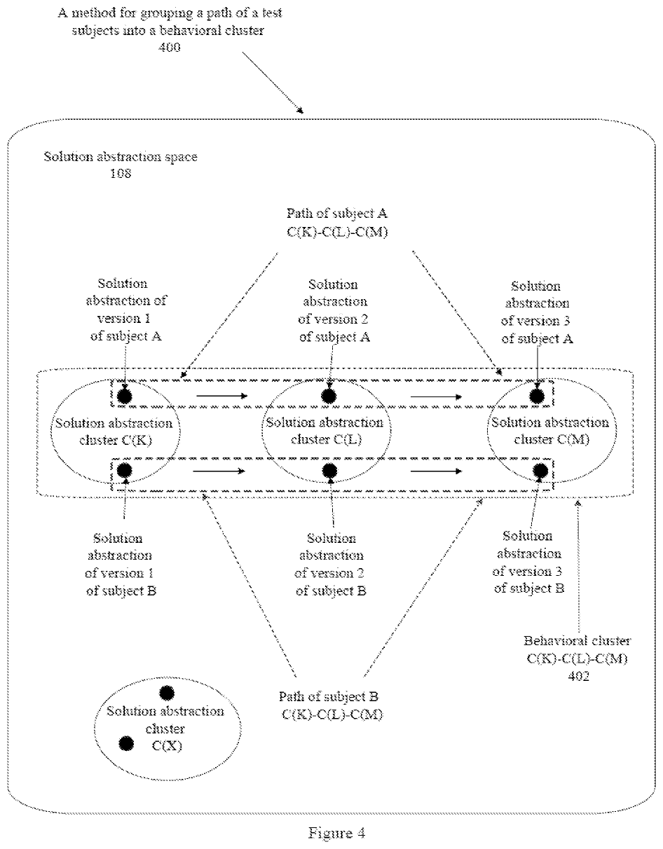

FIG. 4 illustrates step 400 of path generation and grouping into clusters for each subject in a method for classification of study progress of multiple subjects in solving a complex problem. Present system and method are configured to receive multiple solution versions from multiple subjects, thereby tracking progress of multiple subjects through the path of abstractions, for example, graphs, of each of the subjects' solutions through solution abstraction clusters.

FIG. 4 illustrates a schematic view of the space 108, where paths of two different subjects are depicted. Path of subject A is comprised of abstraction solution clusters C(K)-C(L)-C(M), in that specific order, such that abstractions, for example, graphs, of solution versions 1, 2, and 3 submitted by subject A are associated with solution abstraction clusters C(K), C(L), and C(M) respectively. Similarly, Path of subject B is comprised of solution abstraction clusters C(K)-C(L)-C(M), in that specific order, such that abstractions, for example, graphs, of solution versions 1, 2, and 3 submitted by subject B are associated with solution abstraction clusters C(K), C(L), and C(M) respectively. The progress of abstractions, for example, graphs, of solution versions of both the subjects A and B are similar and grouped in similar or same solution clusters. As such, the paths, C(K)-C(L)-C(M) for subject A and C(K)-C(L)-C(M) of subject B, are similar and both the paths are grouped into the same Behavioral Cluster C(K)-C(L)-C(M) 402. The path clustering criteria may allow for grouping of paths that are similar but not identical like shown in this example for simplicity.

1-4. (canceled)

5. A computer implemented method of training a machine learning (ML) artificial intelligence system comprising an ML model, the method comprising:
collecting a plurality of test solutions from first and second subjects, wherein the plurality of test solutions for each of the first and second subjects are test solutions to different test questions answered by the first and second subjects;
creating solution graphs of the collected test solutions;
clustering the solution graphs based on a graph-clustering criterion;
building a path for the first and second subjects, wherein the path of the first and second subjects comprises a sequence of solution graph clusters;
storing the paths of the first and second subjects in a nontransitory storage medium as a behavioral cluster:
preparing a training dataset comprising the behavioral cluster:
training the ML model using the training dataset;
collecting a plurality of test solutions from a third subject:
creating solution graphs of the plurality of test solutions from the third subject:
clustering the plurality of test solutions from the third subject into test solution graph clusters using the trained ML model; and
building a path for the test solution graph clusters from the third test subject and assigning the solution graph clusters from the third test subject to the behavioral cluster.

6-8 (canceled)

9. The method of claim 5, wherein the step of clustering the solution graphs comprises a Density-Based Spatial Clustering of Applications with Noise (DBSCAN) algorithm or a k-nearest neighbors (KNN) algorithm.

10. The method of claim 5, wherein the step of clustering the plurality of test solutions from the third subject comprises classifying a solution graph of the test solutions from the third subject as a new behavioral cluster when the solution graph from the third test subject does not belong to the behavioral cluster.

11. A system for training an artificial intelligence machine learning device for automatic classification of a first subject's progress corresponding to a test for which the first subject submits multiple solutions over a period of time, the system comprising:
a processor coupled to a nontransitory storage medium for storing a training dataset:
a training dataset stored in the nontransitory storage medium, the training dataset comprising solution graphs of test solutions for different questions given by the subject that have been clustered into behavioral clusters;
a machine learning model under program control of the processor:
wherein the machine learning model has been trained on the training dataset and wherein the machine learning model is configured for clustering the solution graphs from a second subject into behavioral clusters.

12. The system of claim 11, wherein the machine learning model is configured to use a solution graph clustering criterion based on a solution graph metric.

13. The system of claim 11, wherein the machine learning model is configured to use path clustering criteria based on a path metric.

14. The system of claim 11, wherein the machine learning model is further configured to assign to a behavioral cluster at least one descriptive label.

15-18. (canceled)

19. The system of claim 11, wherein the machine learning model is configured to use at least one of a Density-Based Spatial Clustering of Applications with Noise (DBSCAN) algorithm or a k-nearest neighbors (KNN) algorithm.

20. The system of claim 11, wherein the machine learning model is further configured to classify a solution graph that does not belong to existing clusters as a new cluster.
